(19) United States
(12) Patent Application Publication
(10) Pub. No.: US 2005/0288102 A1
(43) Pub. Date: Dec. 29, 2005

(54) Method of enabling electronic devices to play an online game at the same time

(75) Inventors: Tony Tsai, Taipei Hsien (TW); David Ho, Taipei Hsien (TW); Hua-Feng Mai, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/873,194

(22) Filed: Jun. 23, 2004

(51) Int. Cl. G06F 19/00; G06F 17/00

(52) U.S. Cl. 463/42

(57) ABSTRACT

The present invention is to provide a method of enabling a plurality of electronic devices to play an online game at the same time, which is implemented in a server and a plurality of electronic devices at a remote end of a network. Each of the electronic devices comprises a network card so that the electronic devices are able to connect to the server. In response to receiving game instructions sent from the electronic devices by the server, the server processes game data for obtaining updated data based on the game instructions, and then sends the updated data to each of the electronic devices. As such, a CPU of each of the electronic devices can receive the updated data, show a game screen on a display thereof and interactively play an online game.

### FIELD OF THE INVENTION

The present invention relates to online games, more particularly to a method of enabling a plurality of electronic devices (e.g., PCs, cellular phones, etc.) to play an online game at the same time.

### BACKGROUND OF THE INVENTION

A wide variety of new and powerful software packages are available due to technological advancements. For example, online game is one type of software. Also, online games are the most popular ones among video game software and its development is fast. Many online game software companies constantly seek to develop various online games so as to be competitive in the market. Also, the magic of online game already attracts many users.

Currently, the mode being adopted by most online games is to install a game software in a PC (personal computer) so that beautiful patterns and pictures and high quality sound effect can be obtained while playing. Next, connect a network card in the PC to a server at a remote end of the network. The server at the remote end of the network is adapted to process data input from a plurality of PCs while playing an online game.

However, PC (e.g., desktop computer) is a bulky device and is not portable (i.e., difficult of moving). Hence, a user may not be able to play an online game anywhere anytime. In contrast, a cellular phone has the advantage of being portable. However, the data transmission rate of the cellular phone over the network is quite low. Thus, the cellular phone cannot meet the needs of high data transmission rate while playing an online game. As an end, it is impossible of playing an online game on the conventional cellular phone.

Therefore, it is quite desirable to provide a method of enabling a plurality of electronic devices (e.g., cellular phones or PCs) to interactively play an online game at the same time. As such, a user may not only use a PC to play an online game but also use his/her cellular phone to play an online game anywhere anytime. Further, the existing electronic devices (e.g., cellular phones, PDAs (Personal Digital Assistants), PCs, etc.) are very powerful and have a network card installed therein. This enables the electronic devices to interactively play an online game at the same time. Advantageously, it not only provides another option for user choice but also brings many business opportunities for electronic device manufacturers.

### SUMMARY OF THE INVENTION

A primary object of the present invention is to provide a method of enabling a plurality of electronic devices to play an online game at the same time. The method is implemented in a server and a plurality of electronic devices at a remote end of a network. Each of the electronic devices comprises a network card so that the electronic devices are able to connect to the server. In response to receiving game instructions sent from the electronic devices by the server, the server processes game data for obtaining updated data based on the game instructions. Next, the server sends the updated data to each of the electronic devices. As such, a CPU of each of the electronic devices can receive the updated data and show a game screen on a display of the electronic device. As an end, the electronic devices are able to interactively play an online game. By utilizing the present invention, the above drawbacks of the prior art can be overcome. These drawbacks are that a user cannot play an online game on PC anywhere anytime. Data transmission rate of cellular phone over the network is quite low. Thus, the cellular phone cannot meet the needs of high data transmission rate while playing an online game.

One object of the present invention is that the electronic devices are adapted to send game instructions inputted by a user and receive updated data sent back from the server. Further, the electronic devices do not process game data. As such, data transmission rate over the network is not high. This enables a portable electronic device having a low data transmission rate to play an online game. As a result, not only PCs but also cellular phones are able to connect to the network and they are able to interactively play an online game at the same time.

The above and other objects, features and advantages of the present invention will become apparent from the following detailed description taken with the accompanying drawings.

### BRIEF DESCRIPTION OF THE DRAWINGS

FIG. 1 is a block diagram for illustrating the connection between a server and a plurality of electronic devices according to the invention;

FIG. 2 is a flow chart illustrating a process of sending signals between the server and the electronic devices according to the invention;

FIG. 3 is a flow chart illustrating a process of identifying a PC prior to playing an online game according to the invention; and

FIG. 4 is a flow chart illustrating a process of identifying a cellular phone prior to playing an online game according to the invention.

### DETAILED DESCRIPTION OF THE PREFERRED EMBODIMENTS

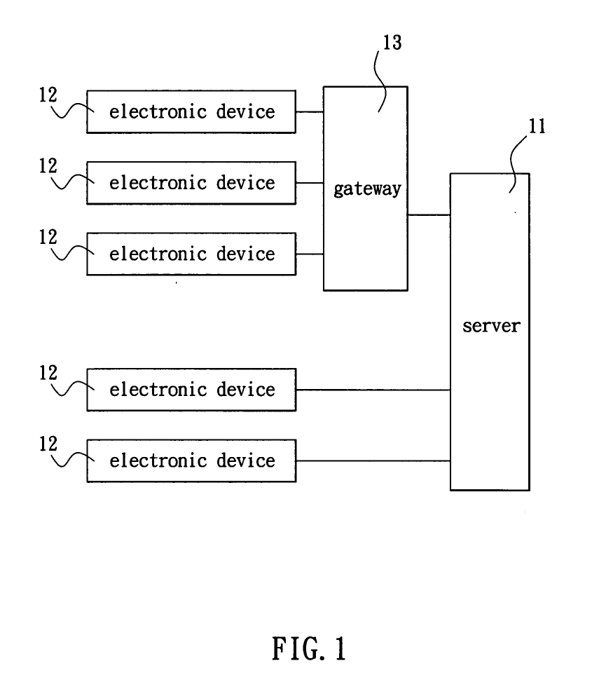

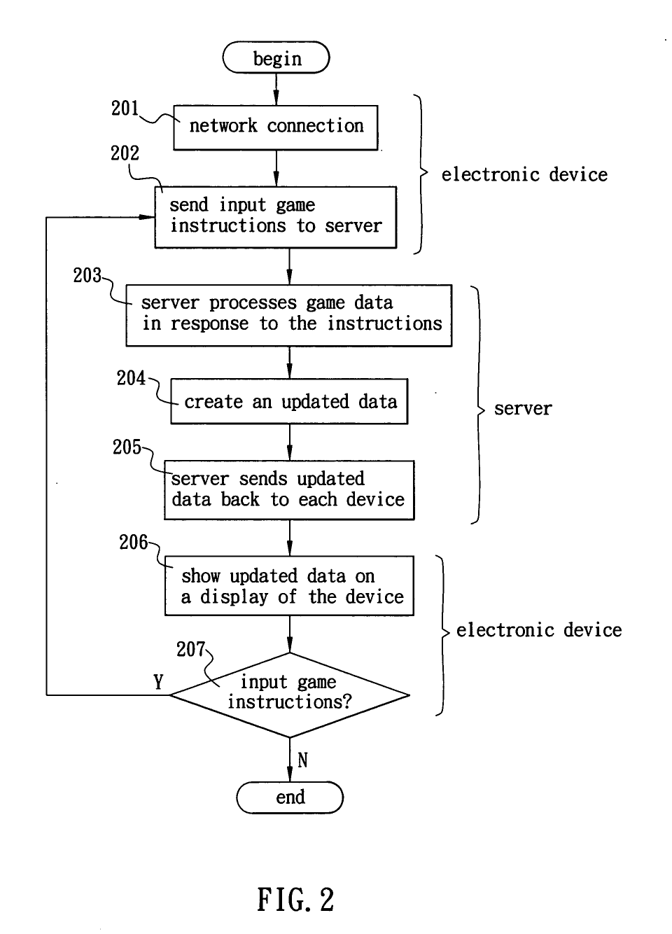

Referring to FIGS. 1 and 2, there is shown a method of enabling a plurality of electronic devices to play an online game at the same time in accordance with the invention. The method is implemented in a server 11 and a plurality of electronic devices (e.g., PCs, cellular phones, etc.) 12 at a remote end of a network. Each of the electronic devices 12 comprises a network card so that the electronic devices 12 are able to connect to the server 11. A CPU (central processing unit) of the electronic device 12 sends game instructions inputted by a user to the server 11. In response to networking the game instructions sent from the electronic device 12, the server 11 processes game data for obtaining updated data based on the game instructions. Next, the server 11 sends the updated data to each of the electronic devices 12. As such, the CPU of each of the electronic devices 12 can receive the updated data and show the updated data on a display of the electronic device 12. As an end, a game screen is shown.

In such a manner, after connecting the network cards to the server 11, all electronic devices 12 are connected to the network. Next, send the game instructions inputted by the user to the server 11 so that the server 11 may process game data in response to the instructions. Updated data is then sent back from the server 11 for creating an updated game screen. As an end, the electronic devices 12 are able to interactively play an online game.

Referring to FIG. 1 again, in the invention some electronic devices 12 are implemented as cellular phones. A gateway 13 is provided between the server 11 and the cellular phones. The gateway 13 is adapted to interconnect two network cards having different protocols. As such, data can be sent between two network cards having different protocols via the gateway 13. Thus, data sent by means of WAP (Wireless Application Protocol) of the cellular phone can reach the server 11. Also, the server 11 can send data back to the cellular phone by means of the protocol used by the gateway 13.

Referring to FIG. 1 again, in the invention the electronic device 12 is a cellular phone. The cellular phone is adapted to send game instructions inputted by the user and receive updated data sent back from the server 11. The cellular phone does not process game data. Instead, game data is processed by the server 11. As such, data transmission rate over the network is not high. This enables a cellular phone having a low data transmission rate to play an online game.

Referring to FIGS. 1 and 2 again, in the invention when all electronic devices 12 are coupled to the server 11 over network by means of the network cards thereof, the electronic devices 12 and the server 11 performs steps comprising:

In step 201, connect all electronic devices 12 to the server 11 over the network.

In step 202, the electronic devices 12 send input game instructions to the server 11.

In step 203, the server 11 processes game data in response to the instructions.

In step 204, create an updated data after the server 11 has processed game data.

In step 205, the server 11 sends the updated data back to respective electronic devices 12 so that the CPU of each electronic device 12 is able to receive the updated data.

In step 206, in response to receiving the updated data by the electronic devices 12, a new game screen is shown on a display of each electronic device 12.

In step 207, it is determined whether game instructions have been inputted. If yes, the process loops back to step 202. Otherwise, the process ends.

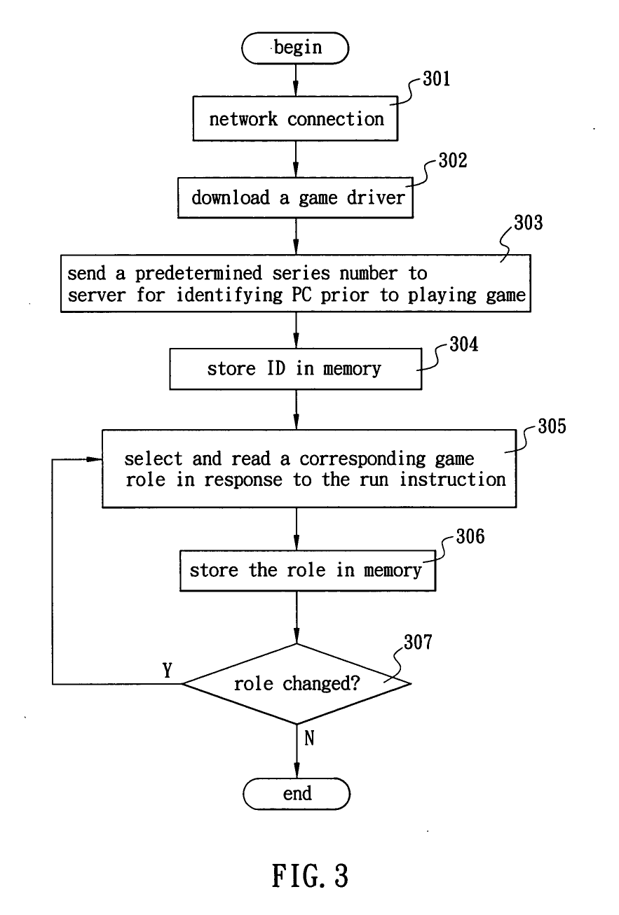

Referring to FIG. 3 in conjunction with FIG. 1, each electronic device 12 is required to be identified by the server 11 prior to playing an online game. The identified electronic device 12 then gains a role of the game prior to connecting to the server 11. As an end, the electronic device 12 can play an online game. In a case of the electronic device 12 being a PC, for enabling the PC to identify itself prior to playing an online game, the CPU of the PC performs steps comprising:

In step 301, connect the PC to the server 11 over the network by means of the network card.

In step 302, download a game driver from the server 11 in response to the instructions.

In step 303, send a predetermined series number to the server 11 for identifying the PC prior to playing an online game.

In step 304, store the obtained identification in a memory.

In step 305, select and read a corresponding game role in response to the run instruction.

In step 306, store the role in the memory.

In step 307, it is determined whether the role has been changed. If yes, the process loops back to step 305. Otherwise, the process ends.

In such a manner, once the PC is connected to the server 11, a user can manipulate the role (e.g., flying, jumping, hitting, etc.) while playing the online game.

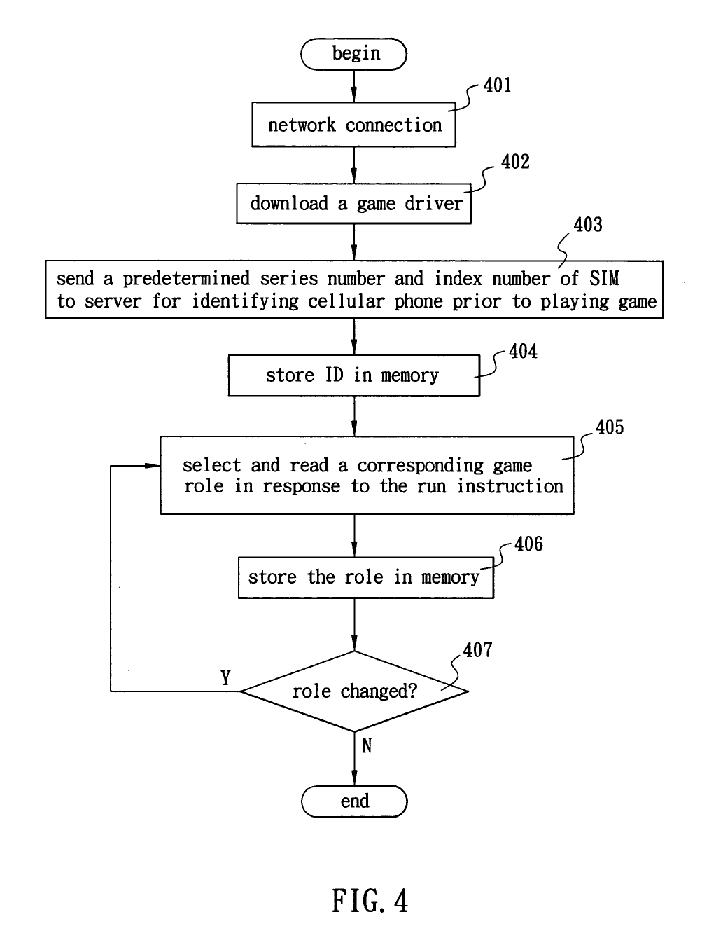

Referring to FIG. 4 in conjunction with FIG. 1, each electronic device 12 is required to be identified by the server 11 prior to playing an online game. The identified electronic device 12 then gains a role of the game prior to connecting to the server 11. As an end, the electronic device 12 can play an online game. In a case of the electronic device 12 being a cellular phone, for enabling the cellular phone to identify itself prior to playing an online game, a microprocessor of the cellular phone performs steps comprising:

In step 401, connect the cellular phone to the server 11 over the network by means of the network card.

In step 402, download a game driver from the server 11 in response to the instructions.

In step 403, send a predetermined series number and the index number of SIM (Subscriber Identity Module) to the server 11 for identifying the cellular phone prior to playing an online game.

In step 404, store the obtained identification in a memory.

In step 405, select and read a corresponding game role in response to the run instruction.

In step 406, store the role in the memory.

In step 407, it is determined whether the role has been changed. If yes, the process loops back to step 405. Otherwise, the process ends.

In such a manner, once the cellular phone is connected to the server 11, a user can manipulate the role (e.g., flying, jumping, hitting, etc.) while playing the online game.

While the invention has been described by means of specific embodiments, numerous modifications and variations could be made thereto by those skilled in the art without departing from the scope and spirit of the invention set forth in the claims.

1. A method of enabling a plurality of electronic devices to play an online game at the same time, the method being implemented in a server and a plurality of electronic devices at a remote end of a network, each of the electronic devices including a network card so that the electronic devices are able to connect to the server over network by means of the network cards thereof, and in response, the electronic devices and the server performs steps comprising:
enabling the electronic devices to send input game instructions to the server;
enabling the server to process game data in response to the instructions;
creating an updated data after the server has processed game data;
enabling server to send the updated data back to each of the electronic devices so that a CPU of each of the electronic devices is able to receive the updated data; and
in response to receiving the updated data by the electronic devices, showing a new game screen on a display of each of the electronic devices.

2. The method of claim 1, wherein each of the electronic devices is identified by the server prior to playing the online game, the identified electronic device gains a role of the online game prior to connecting to the server, the electronic devices are able to play the online game, and for enabling the electronic devices to identify itself prior to playing the online game, the CPU of each of the electronic devices performs steps comprising:
connecting each of the electronic devices to the server over the network by means of the network card;
downloading a game driver from the server in response to the instructions;
sending a predetermined series number to the server for identifying the electronic device prior to playing the online game;
storing the obtained identification in a memory;
selecting and reading a corresponding game role in response to the run instruction; and
storing the game role in the memory.

3. The method of claim 1, wherein the electronic device is a PC.

4. The method of claim 1, wherein the electronic device is a cellular phone.
